(19) United States
(12) Patent Application Publication
(10) Pub. No.: US 2010/0298475 A1
(43) Pub. Date: Nov. 25, 2010

(54) IGNITION RESISTANT CARBONATE POLYMER COMPOSITION CONTAINING AN AROMATIC PHOSPHONATE

(76) Inventors: David R. Wilson, Midland, MI (US); Ravi B. Shankar, Midland, MI (US); Ashwin R. Bharadwaj, Midland, MI (US); Bruce A. King, Midland, MI (US)

Correspondence Address: The Dow Chemical Company, P.O. BOX 1967, Midland, MI, 48641, US

(21) Appl. No.: 12/747,108

(22) PCT Filed: Jan. 8, 2009
(86) PCT No.: PCT/US09/30381

§ 371 Date: Jun. 9, 2010

Related U.S. Application Data
(60) Provisional application No. 61/020,804, filed on Jan. 14, 2008.

(51) Int. Cl. C08K 5/5317

(52) U.S. Cl. 524/119; 524/117; 524/125

(57) ABSTRACT

The present invention relates to flame resistance additives for organic polymers, and in particular polyphosphonate-type flame resistance additives in a polycarbonate or a polyester carbonate and/or in blends of polycarbonate or a polyester carbonate with an acrylonitrile, butadiene, and styrene terpolymer. The aromatic polyphosphonate compounds of the present invention are represented by the structure, wherein a and b are each from 0 to 6, with a+b being from 2 to 6, each R is independently hydrogen, unsubstituted or inertly substituted alkyl having up to 6 carbon atoms, —NO₂, —NR¹₂, —C≡N, —OR¹, —C(O)OR¹, or —C(O)NR¹₂ (wherein R¹ is hydrocarbyl or hydrogen), each R2 is independently hydrogen, alkyl or inertly substituted alkyl, each R³ is a covalent bond or a divalent linking group, and each R⁴ is independently an alkyl, aryl, inertly substituted alkyl or inertly substituted aryl group.

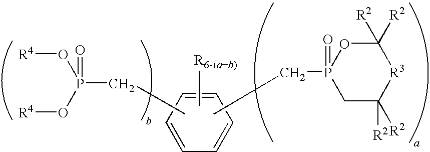

This application claims benefit of U.S. Provisional Application No. 61/020,804, filed Jan. 14, 2008.

### FIELD OF THE INVENTION

The present invention relates to ignition resistant additives for organic polymers, and in particular polyphosphonate compounds as ignition resistant additives in a polycarbonate (PC) or a polyester carbonate (PEC) and/or in blends of PC or PEC with an acrylonitrile, butadiene, and styrene terpolymer (ABS).

### BACKGROUND OF THE INVENTION

Various phosphorus compounds have been used as ignition resistant (IR) additives. These include organic phosphates, phosphonates and phosphoramides, some of which are described in U.S. Pat. Nos. 4,070,336; 4,086,205; 4,255,324; 4,268,459; and 4,278,588; and NL 8004920.

Among the phosphorus compounds that have been evaluated are certain bis(cyclic phosphonate) compounds corresponding to the structure:

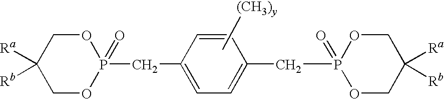

wherein each R^{a} is hydrogen or methyl, R^{b} is hydrogen, methyl or ethyl, y is an integer from 0 to 2, and the phosphonate groups are attached to methylene groups that are in the para position with respect to each other. U.S. Pat. No. 4,268,459 reports that these compounds were evaluated as IR additives in polypropylene and poly(ethylene terephthalate). According to this patent, polypropylene containing 15 percent by weight of compound of this type are self-extinguishing when evaluated according to ASTM D-635. The patent further reports that adding 10 percent by weight of these compounds to poly(ethylene terephthalate) increases its limiting oxygen index from 19.4 to 24.0.

However, similar results have not been reported when those bis(cyclic phosphonate) compounds have been evaluated in other polymers. For example, NL 8004920 reports the evaluation of the same compounds in a 50:50 blend of polyphenylene oxide and an impact-modified polystyrene. According to NL 8004920, incorporation of 4 to 6 percent of the bis(cyclic phosphonate) compound into this blend provides a material that is rated “free-burning” when tested per UL 94 Vertical Test Method 3.10-3.15. Therefore, the efficacy of the bis(cyclic phosphonate) compounds appears to depend on the particular polymer system under investigation.

The flame retardant properties of other phosphorus compounds also appear to depend on the organic polymer system in which they are used. For example, in U.S. Pat. No. 4,278,588, certain phosphine oxide compounds are reported to impart a V-O or V-1 rating (according to the UL 94 test) at levels of 4 to 6 percent in polyphenylene oxide/impact-modified polystyrene blends. However, that patent reports that levels as high as 20 percent are ineffective when blended into the impact-modified polystyrene by itself (i.e., without the polyphenylene oxide).

### SUMMARY OF THE INVENTION

The present invention is in one aspect an ignition resistant carbonate polymer composition comprising (i) an aromatic polycarbonate or an aromatic polyester carbonate, (ii) optionally a graft polymer of (ii.a) one or more vinyl monomers on (ii.b) one or more grafting backbones with a glass transition temperature (T_{g}) of less than 10° C., (iii) optionally at least one thermoplastic vinyl (co)polymer, (iv) an aromatic polyphosphonate compound represented by the structure:

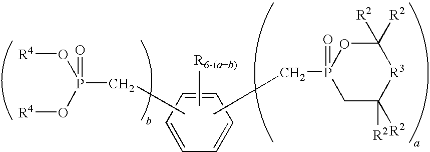

wherein a and b are each from 0 to 6, with a+b being from 2 to 6, each R is independently hydrogen, unsubstituted or inertly substituted alkyl having up to 6 carbon atoms, —NO₂, —NR¹₂, —C≡N, —OR¹, —C(O)OR¹, —C(O)R¹, —C(O)H, or —C(O)NR¹₂ (wherein R¹ is hydrocarbyl or hydrogen), each R² is independently hydrogen, alkyl or inertly substituted alkyl, each R³ is a covalent bond or a divalent linking group, and each R⁴ is independently an alkyl, aryl, inertly substituted alkyl or inertly substituted aryl group, and (v) optionally a fluorinated polyolefin.

In a preferred embodiment of the present invention the aromatic polyphosphonate is represented by the structure:

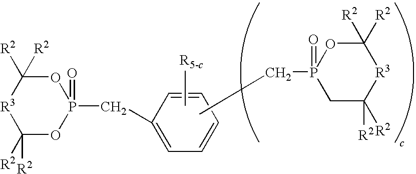

wherein c is 1 to 5, each R is independently hydrogen, unsubstituted or inertly substituted alkyl having up to 6 carbon atoms, —NO₂, —NR¹₂, —C≡N, —OR¹, —C(O)OR¹, —C(O)R¹, —C(O)H, or —C(O)NR¹₂ (wherein R¹ is hydrocarbyl or hydrogen), each R² is independently hydrogen, alkyl or inertly substituted alkyl and each R³ is a covalent bond or a divalent linking group; preferably each R is hydrogen or unsubstituted alkyl having up to 4 carbon atoms; each R² is hydrogen; each R³ is an alkylene diradical having no hydrogens on the carbon atom(s) bonded directly to the adjacent (R²)₂C groups, and c is from 1 to 3; and more preferably each R is hydrogen; each R² is hydrogen; and each R³ is dimethylmethylene (propylidene).

In another embodiment of the present invention the aromatic polyphosphonate is represented by the structure:

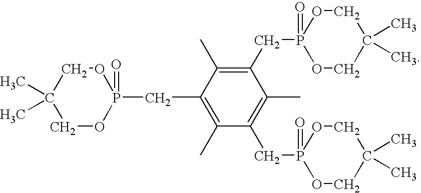

In another embodiment of the present invention the aromatic polyphosphonate is represented by the structure:

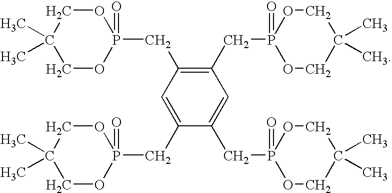

In another embodiment of the present invention the aromatic polyphosphonate is represented by the structure:

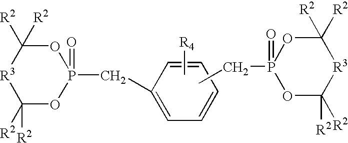

wherein R, R², and R³ are as defined hereinabove.

In another embodiment of the present invention the aromatic polyphosphonate is represented by the structure:

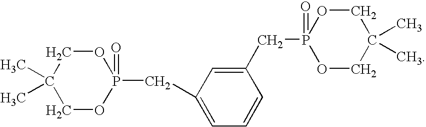

In another embodiment of the present invention the aromatic polyphosphonate is represented by the structure:

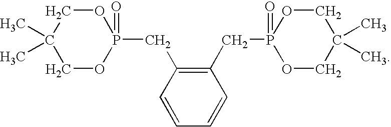

In another embodiment of the present invention the aromatic polyphosphate is represented by structure:

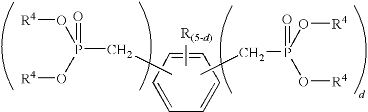

wherein R and R⁴ are as defined hereinabove and d is from 1 to 5.

In another embodiment of the present invention the aromatic polyphosphate is represented by the structure:

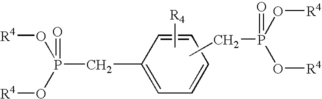

wherein R and R⁴ are as defined hereinabove.

In further preferred embodiments: component (ii) is present in an amount of from about 0.5 to about 60 parts by weight, component (iii) is present in an amount of from about 2 to 25 parts by weight, component (iv) is present in an amount of from about 1 to 20 parts by weight, component (v) is present in an amount of from about 0.05 to 3 parts by weight, the ratio by weight of components (ii):(iii) is between 2:1 and 1:4, the graft base (ii.b) is a diene rubber, an acrylate rubber, a silicone rubber, or an ethylene-propylene diene rubber, and the ignition resistant carbonate polymer composition further comprising from about 1 to 40 parts by weight of one or more of glass fibers, glass beads, mica, silicates, quartz, talcum, titanium dioxide, or wollastonite alone or in combination.

A further embodiment is a method for making the ignition resistant carbonate polymer compositions described hereinabove.

A further embodiment of the present invention is a formed article of the ignition resistant carbonate polymer composition of the present invention, preferably made by one or more of the following fabricating processes: compression molding, injection molding, gas assisted injection molding, calendaring, vacuum forming, thermoforming, extrusion, or blow molding, alone or in combination.

### DETAILED DESCRIPTION OF THE INVENTION

Component (i) of the present invention is a thermoplastic aromatic polycarbonate and/or aromatic polyester carbonate. Suitable aromatic polycarbonates and/or aromatic polyester carbonates according to the invention are known from the literature or can be produced by methods known from the literature (for example, for the production of aromatic polycarbonates, see Schnell, “Chemistry and Physics of Polycarbonates”, Interscience Publishers, 1964, as well as U.S. Pat. Nos. 3,028,365; 4,529,791; and 4,677,162; which are hereby incorporated by reference in their entirety. Suitable aromatic polyester carbonates are described in U.S. Pat. Nos. 3,169,121; 4,156,069; and 4,260,731; which are hereby incorporated by reference in their entirety.

The production of aromatic polycarbonates is effected, for example, by the reaction of diphenols with carbonic acid halides, preferably phosgene, and/or with aromatic dicarboxylic acid dihalides, preferably benzenedicarboxylic acid dihalides, by the phase boundary method, optionally with the use of chain terminators, e.g., monophenols, and optionally with the use of trifunctional branching agents or branching agents with a functionality higher than three, for example triphenols or tetraphenols.

Diphenols for the production of the aromatic polycarbonates and/or aromatic polyester carbonates are preferably those of formula I

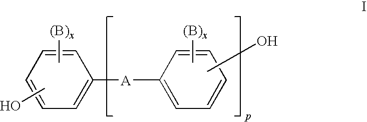

wherein A denotes a single bond, a C₁-C₅ alkylene, a C₂-C₅ alkylidene, a C₅-C₆ cycloalkylidene, —O—, —SO—, —CO—, —S—, —SO₂—, or a C₆-C₁₂ arylene, on to which other aromatic rings, which optionally contain hetero atoms, can be condensed, or a radical of formula II or III

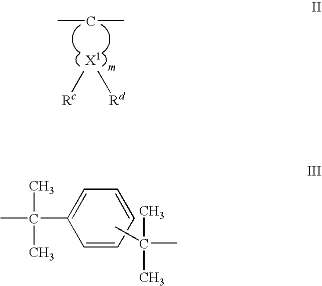

B in each case is independently hydrogen, a C₁-C₁₂ alkyl, preferably methyl, or a halogen, preferably chlorine and/or bromine;
x in each case is mutually independently 0, 1, or 2;
p is 0 or 1;
R^{c} and R^{d} are mutually independent of each other and are individually selectable for each X¹ and are hydrogen or a C₁-C₆ alkyl, preferably hydrogen, methyl or ethyl;
X¹ denotes carbon; and
m denotes an integer from 4 to 7, preferably 4 or 5, with the proviso that R^{c} and R^{d} simultaneously denote an alkyl on at least one X₁ atom.

The preferred diphenols are hydroquinone, resorcinol, dihydroxybiphenyls, bis(hydroxyphenyl)-C₁-C₅ alkanes, bis(hydroxyphenyl)-C₅-C₆ cycloalkanes, bis(hydroxyphenyl)ethers, bis(hydroxyphenyl)sulfoxides, bis(hydroxyphenyl)ketones, bis(hydroxyphenyl)sulfones and alpha, alpha′-bis(hydroxyphenyl)diisopropylbenzenes, as well as derivatives thereof which have brominated and/or chlorinated nuclei.

Diphenols which are particularly preferred are 4,4′-dihydroxybiphenyl, bisphenol A, 2,4-bis(4-hydroxyphenyl)-2-methylbutane, 1,1-bis(4-hydroxyphenyl)-cyclohexane, 1,1-bis(4-hydroxyphenyl)-3,3,5-trimethylcyclohexane, 4,4-dihydroxydiphenyl sulfide and 4,4-dihydroxydiphenyl sulfone, as well as di- and tetrabrominated or chlorinated derivatives thereof, such as 2,2-bis(3-chloro-4-hydroxyphenyl)propane, 2,2-bis-(3,5-dichloro-4-hydroxyphenyl)propane or 2,2-bis(3,5-dibromo-4-hydroxyphenyl)propane. 2,2-Bis-(4-hydroxyphenyl)propane (bisphenol A) is particularly preferred. The diphenols can be used individually or as arbitrary mixtures. The diphenols are known from the literature or can be obtained by methods known from the literature.

Examples of suitable chain terminators for the production of the aromatic polycarbonates include phenol, p-chlorophenol, p-tert-butylphenol or 2,4,6-tribromophenol, as well as long chain alkylphenols such as 4-(1,3-dimethyl-butyl)-phenol or monoalkylphenols or dialkylphenols which contain a total of 8 to 20 C atoms in their alkyl substituents, such as 3,5-di-tert-butyl-phenol, p-iso-octylphenol, p-tert-octylphenol, p-dodecylphenol, 2-(3,5-dimethylheptyl)-phenol and 4-(3,5-dimethylheptyl)-phenol. The amount of chain terminators used is generally between 0.1 mole percent and 10 mole percent with respect to the molar sum of the diphenols used in each case.

The aromatic polycarbonates and/or aromatic polyester carbonates of the present invention preferably have a mean weight average molecular weights of from about 10,000 to about 200,000 preferably about 20,000 to about 80,000. Unless otherwise indicated, the references to aromatic polycarbonate and/or aromatic polyester carbonate “molecular weight” herein refer to weight average molecular weights (M_{w}) determined by gel permeation chromatography (GPC) using laser scattering techniques with a bisphenol A polycarbonate standard and is given in units of grams per mole (g/mole).

The aromatic polycarbonates can be branched in the known manner, for example by the incorporation of 0.05 to 2.0 mole percent, with respect to the sum of the diphenols used, of trifunctional compounds or of compounds with a functionality higher than three, for example those which contain three or more phenolic groups. Branched polycarbonates suitable for the present invention can be prepared by known techniques, for example several suitable methods are disclosed in U.S. Pat. Nos. 3,028,365; 4,529,791; and 4,677,162; which are hereby incorporated by reference in their entirety.

Suitable branching agents that may be used are tri- or multi-functional carboxylic acid chlorides, such as trimesic acid trichloride, cyanuric acid trichloride, 3,3′-,4,4′-benzophenonetetracarboxylic acid tetrachloride, 1,4,5,8-naphthalene-tetracarboxylic acid tetrachloride or pyromellitic acid tetrachloride for example, in amounts of 0.01 to 1.0 mole percent (with respect to the dicarboxylic acid dichlorides used) or tri- or multi-functional phenols such as phloroglucinol, 4,6-dimethyl-2,4,6-tris(4-hydroxyphenyl)-2-heptene, 4,4-dimethyl-2,4,6-tris(4-hydroxyphenyl)heptane, 1,3,5-tris(4-hydroxyphenyl)benzene, 1,1,1-tris(4-hydroxyphenyl)ethane, tris(4-hydroxyphenyl)-phenyl-methane, 2,2-bis[4,4-bis(4-hydroxyphenyl)cyclohexyl]-propane, 2,4-bis[1-(4-hydroxyphenyl)-1-methylethyl]phenol, tetrakis(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)propane, or tetrakis(4-[1-(4-hydroxyphenyl)-1-methylethyl]-phenoxy)-methane in amounts of 0.01 to 1.0 mole percent with respect to the diphenols used. Phenolic branching agents can be placed in the reaction vessel with the diphenols. Acid chloride branching agents can be introduced together with the acid chlorides.

Both homopolycarbonates and copolycarbonates are suitable. For the production of copolycarbonates according to component (i) in accordance with the invention, 1 to 25 percent by weight, preferably 2.5 to 25 percent by weight (with respect to the total amount of diphenols to be used) of polydiorganosiloxanes comprising hydroxy-aryloxy terminal groups can also be used. These are known (see, for example, U.S. Pat. No. 3,419,634) or can be produced by methods known from the literature.

Apart from bisphenol A homopolycarbonates, the preferred polycarbonates are the copolycarbonates of bisphenol A with up to 15 mole percent, with respect to the molar sums of the diphenols, of other diphenols which are cited as preferred or particularly preferred, in particular 2,2-bis(3,5-dibromo-4-hydroxyphenyl)-propane.

The preferred aromatic dicarboxylic acid dihalides for the production of the aromatic polyester carbonates are the diacid dichlorides of isophthalic acid, terephthalic acid, diphenyl ether-4,4′-dicarboxylic acid and naphthalene-2,6-dicarboxylic acid. Mixtures of the diacid dichlorides of isophthalic acid and terephthalic in a ratio between 1:20 and 20:1 are particularly preferred. A carbonic acid halide, preferably phosgene, is used in conjunction as a difunctional acid derivative during the production of the polyester carbonates.

Apart from the aforementioned monophenols, suitable chain terminators for the production of the aromatic polyester carbonates include chlorocarboxylic acid esters thereof, as well as the acid chlorides of aromatic monocarboxylic acids which may optionally be substituted by C₁-C₂₂ alkyl groups, or by halogen atoms, and also include aliphatic C₂-C₂₂ monocarboxylic acid chlorides. The amount of chain terminator is 0.1 to 10 mole percent in each case, with respect to the moles of diphenols in the case of phenolic chain terminators and with respect to the moles of dicarboxylic acid dichlorides in the case of monocarboxylic acid chloride chain terminators.

The aromatic polyester carbonates may also contain incorporated hydroxycarboxylic acids. The aromatic polyester carbonates may be either linear or may be branched. Suitable branching agents are disclosed hereinabove.

The proportion of carbonate structural units in the aromatic polyester carbonates can be arbitrarily varied. The content of carbonate groups is preferably up to 100 mole percent, particularly up to 80 mole percent, most preferably up to 50 mole percent, with respect to the sum of ester groups and carbonate groups. Both the ester and the carbonate fraction of the aromatic polyester carbonates can be present in the form of blocks, or can be randomly distributed in the condensation polymer.

The relative solution viscosity (ηᵣₑₗ) of the aromatic polycarbonates and aromatic polyester carbonates is within the range of 1.18 to 1.4, preferably 1.22 to 1.3 (as measured on solutions of 0.5 g of polycarbonate and polyester carbonate, respectively, in 100 mL of methylene chloride at 25° C.).

The aromatic polycarbonates and aromatic polyester carbonates can be used individually or in any mixture with each other.

The thermoplastic aromatic polycarbonates and/or aromatic polyester carbonates (i) are present in an amount equal to or greater than about 40 parts by weight, preferably equal to or greater than about 50 parts, and more preferably equal to or greater than about 60 parts by weight based on the weight of the ignition resistant carbonate polymer composition. The thermoplastic aromatic polycarbonates and/or aromatic polyester carbonates (i) are present in an amount equal to or less than about 99 parts by weight, preferably equal to or greater than about 95 parts, more preferably equal to or greater than about 90 parts, more preferably equal to or less than about 85 parts, and more preferably equal to or less than about 80 parts by weight based on the weight of the ignition resistant carbonate polymer composition. Unless stated otherwise, parts by weight are based on the total weight of the ignition resistant carbonate polymer composition.

Component (ii) of the present invention is one or more graft copolymers of (ii.a) 5 to 95, preferably 30 to 80 percent by weight, of one or more vinyl monomers on (ii.b) 95 to 5, preferably 70 to 20 percent by weight of one or more grafting backbones with a glass transition temperature less than 10° C., preferably less than 0° C., preferably less than about −10° C., and more preferably less than −20° C. The grafting backbone (ii.b) generally has an average particle size (D₄₃, value) of from 0.10 to 5 microns.

Monomers (ii.a) are preferably mixtures of

(ii.a.1) 50 to 99 parts by weight of aromatic vinyl compounds and/or aromatic vinyl compounds with substituted nuclei (such as styrene, alpha-methylstyrene, p-methylstyrene or p-chlorostyrene) and/or C₁-C₄ alkyl esters of (meth)acrylic acid (such as methyl methacrylate or ethyl methacrylate), and
(ii.a.2) 1 to 50 parts by weight of vinyl cyanides (unsaturated nitriles, such as acrylonitrile and methacrylonitrile) and/or C₁-C₄ alkyl esters of (meth)acrylic acid (such as methyl methacrylate, n-butyl acrylate and t-butyl acrylate) and/or derivatives (such as anhydrides and imides) of unsaturated carboxylic acids (for example maleic anhydride and N-phenylmaleimide).

The preferred monomers (ii.a.1) are selected from at least one of the monomers styrene, alpha-methylstyrene and methyl methacrylate. The preferred monomers (ii.a.2) are selected from at least one of the monomers acrylonitrile, maleic anhydride and methyl methacrylate. The monomers which are particularly preferred are styrene as (ii.a.1) and acrylonitrile as (ii.a.2).

Examples of suitable grafting backbones (ii.b) for graft polymers (ii) include diene rubbers, ethylene/propylene and optionally diene (EP(D)M) rubbers, acrylate, polyurethane, silicone, chloroprene and ethylene/vinyl acetate rubbers.

The preferred grafting backbones (ii.b) are diene rubbers (for example based on butadiene, isoprene, etc.) or mixtures of diene rubbers or copolymers of diene rubbers or mixtures thereof with other copolymerizable monomers (for example according to (ii.a.1) and (ii.a.2)), providing that the glass transition temperature is less than about 10° C., preferably less than about 0° C., preferably less than about −10° C., and more preferably less than about −20° C. Pure polybutadiene rubber is particularly preferred. A particularly preferred graft polymer (ii) is acrylonitrile, butadiene, and styrene terpolymer (ABS).

Graft copolymers (ii) are produced by radical polymerization, for example by emulsion, suspension, solution or bulk polymerization. For examples of the bulk, mass-solution, or mass-suspension polymerization, which are generally known as mass polymerization processes, see U.S. Pat. Nos. 3,660,535; 3,243,481; and 4,239,863; which are incorporated herein by reference. Suitable ABS polymers may be produced by redox initiation with an initiator system comprising an organic hydroperoxide and ascorbic acid according to U.S. Pat. No. 4,937,285; which is incorporated herein by reference. Depending on the desired end properties (for example impact strength, weld line strength, gloss, tensile properties, flexural properties, etc.) of the ignition resistant carbonate polymer composition of the present invention, emulsion polymerized graft polymer may be preferred or mass polymerized graft polymer may be preferred or a mixture of emulsion polymerized and mass polymerized graft polymer may be preferred.

Suitable acrylate rubbers according to (ii.b) of polymer (ii) are preferably polymers of acrylic acid alkyl esters, optionally with up to 40 percent by weight, with respect to (ii.b), of other polymerizable, ethylenically unsaturated monomers. The preferred polymerizable acrylic acid esters include C₁-C₈ alkyl esters, for example methyl, ethyl, butyl, n-octyl and 2-ethylhexyl esters: halogenoalkyl esters, preferably halogeno-C₁-C₈-alkyl esters such as chloroethyl acrylate, as well as mixtures of these monomers.

Monomers with more than one polymerizable double bond can be copolymerized to provide cross-linking. The preferred examples of cross-linking monomers are the esters of unsaturated monocarboxylic acids containing 3 to 8 C atoms and unsaturated monohydric alcohols containing 3 to 12 C atoms, or saturated polyols containing 2 to 4 OH groups and 2 to 20 C atoms, such as ethylene glycol dimethacrylate or allyl methacrylate for example; multiply-unsaturated heterocyclic compounds, such as trivinyl and triallyl cyanurate for example; polyfunctional vinyl compounds such as di- and trivinylbenzenes; and also triallyl phosphate and diallyl phthalate.

The preferred cross-linking monomers are allyl methacrylate, ethylene glycol dimethacrylate, diallyl phthalate and heterocyclic compounds which contain at least 3 ethylenically unsaturated groups. Cross-linking monomers which are particularly preferred are the cyclic monomers triallyl cyanurate, triallyl isocyanurate, triacryloyl hexahydro-s-triazine and triallylbenzenes. The amount of cross-linked monomer is preferably 0.02 to 5, particularly 0.05 to 2 percent by weight, with respect to graft base (ii.b). For cyclic cross-linking monomers containing at least 3 ethylenically unsaturated groups, it is advantageous to restrict the amount thereof to less than 1 percent by weight of graft base (ii.b).

Examples of preferred “other” polymerizable, ethylenically unsaturated monomers which can optionally be employed apart from acrylic acid esters for the production of graft base (ii.b) include acrylonitrile, styrene, alpha-methylstyrene, acrylamides, vinyl-C₁-C₆-alkyl ethers, methyl methacrylate and butadiene. The acrylate rubbers which are preferred as the grafting backbone (ii.b) are emulsion polymers which have a gel content of at least 20 percent, preferably 40 percent, more preferably 60 percent by weight.

Other grafting backbones which are suitable according to (ii.b) are silicone rubbers with graft-active sites.

Since, as is known, the graft monomers (ii.a) are not grafted completely on to the grafting backbone (ii.b) during the grafting reaction, graft polymers (ii) are also to be understood according to the invention to include those products which are obtained by (co)polymerization of the graft monomers in the presence of the graft base and which occur in conjunction during processing (i.e., (co)polymer from the polymerization of graft monomer (ii.a)).

Unless otherwise indicated, the average graft base particle size is a volume-weighted mean particle diameter (D₄₃) determined by analyzing Transmission Electron Microscopy (TEM) images, for example, see U.S. Pat. Nos. 6,380,303 and 6,306,962, which are incorporated herein by reference. Typically, a correction for section thickness is done when particles are larger than 1 micron.

The average particle diameter of the grafting backbone (ii.b) is equal to or greater than about 0.05 microns, preferably equal to or greater than about 0.1 microns, more preferably equal to or greater than about 0.15 microns, more preferably equal to or greater than about 0.2 microns, and even more preferably equal to or greater than about 0.25 microns. The average particle diameter of the grafting backbone (ii.b) is equal to or less than about 5 microns, preferably equal to or less than about 2 microns, more preferably equal to or less than about 1.5 microns, more preferably equal to or less than about 1 micron, more preferably equal to or less than about 0.6 microns, more preferably equal to or less than about 0.5 microns, more preferably equal to or less than about 0.4 microns, more preferably equal to or less than about 3.5 microns, and even more preferably equal to or less than about 0.3 microns.

The rubber-modified polymers of the present invention can have both a broad monomodal particle size distribution or a multi-modal particle size distribution, for example, bimodal particle size distribution. In either case, the rubber components can comprise one rubber or a blend of rubbers. In particular, more than one rubber can be used in a monomodal or bimodal process. A bimodal rubber particle size distribution is defined as having two distinct peaks of particles when graphed on axes of particle size vs volume fraction, whereby one peak designates smaller particles and the other peak designates larger particles.

Typically, in a bimodal particle size distribution, the larger particle fraction will have a volume average particle size of from about 0.5 microns, preferably from about 0.6 microns, more preferably from about 0.7 microns, and most preferably from about 0.8 microns to about 3 microns, preferably to about 2.5 microns, more preferably to about 2 microns, and most preferably to about 1.5 microns. Typically, the smaller particle fraction will have a volume average particle size of from about 0.075 microns, preferably from about 0.1 microns to 0.3 microns, preferably to about 0.25 microns, and more preferably to about 0.2 microns.

The gel content of graft base (iii.b) can be determined at 25° C. in a suitable solvent. The gel content of an emulsion produced graft base (ii.b) is at least 20 percent by weight, preferably at least 30 percent, more preferably at least 40 percent, even more preferably at least 50 percent, and most preferably at least 60 percent by weight as measured in toluene.

If present, the graft polymer (ii) is present in an amount equal to or greater than about 0.5 parts by weight, preferably equal to or greater than about 1 part, more preferably equal to or greater than about 2 parts, more preferably equal to or greater than about 5 parts, and more preferably equal to or greater than about 10 parts by weight based on the weight of the ignition resistant carbonate polymer composition. If present, the graft polymer (ii) is present in an amount equal to or less than about 60 parts by weight, preferably equal to or less than about 50 parts, more preferably equal to or less than about 40 parts, more preferably equal to or less than about 30 parts, and more preferably equal to or less than about 25 parts by weight based on the weight of the ignition resistant carbonate polymer composition.

Component (iii) of the present invention comprises one or more thermoplastic vinyl (co)polymers. Polymers which are suitable as component (iii) are polymers of at least one monomer from the group comprising aromatic vinyl compounds, vinyl cyanides (unsaturated nitrites), (meth)acrylic acid (C₁-C₈)-alkyl esters, unsaturated carboxylic acids, as well as derivatives (such as anhydrides and imides) of unsaturated carboxylic acids.

(Co)polymers which are particularly suitable are those of (iii.a) in an amount of from 50 to 99, preferably 60 to 80 parts by weight of aromatic vinyl compounds and/or aromatic vinyl compounds which comprise substituted nuclei, such as styrene, alpha-methylstyrene, p-methylstyrene, p-chlorostyrene and/or methacrylic acid (C₁-C₄)-alkyl esters, such as methyl methacrylate or ethyl methacrylate, and (iii.b) in an amount of from 1 to 50, preferably 20 to 40 parts by weight vinyl cyanides (unsaturated nitrites) such as acrylonitrile and methacrylonitrile and/or (meth)acrylic acid (C₁-C₈) esters (such as methyl methacrylate, n-butyl acrylate or t-butyl acrylate) and/or unsaturated carboxylic acids (such as maleic acid) and/or derivatives (such as anhydrides and imides) of unsaturated carboxylic acids (for example maleic anhydride and N-phenyl-maleimide).

The copolymer of (iii.a) styrene and (iii.b) acrylonitrile (SAN) is particularly preferred.

(Co)polymers (iii) are thermoplastic and free from rubber. The (co)polymers according to (iii) are known, and can be produced by radical polymerization, particularly by emulsion, suspension, solution or bulk (mass) polymerization. The (co)polymers according to component (iii) preferably have molecular weights M_{w} (weight average, as determined by GPC using laser scattering techniques and narrow molecular weight polystyrene standards) between 15,000 and 200,000.

(Co)polymers according to component (iii) are frequently produced as by-products during the graft polymerization of component (ii), particularly when large amounts of monomers (ii.a) are grafted on to small amounts of rubber (ii.b). The amount of (iii) which can also optionally be used according to the invention does not include these by-products of the graft polymerization of (ii).

If component (iii) is present in the ignition resistant carbonate polymer compositions according to the invention, the ratio by weight of components (ii):(iii) may desirably be between 2:1 and 1:4, preferably between 1:1 and 1:2.

If present, the thermoplastic vinyl (co)polymer (iii) is present in an amount equal to or greater than about 0.5 parts by weight, preferably equal to or greater than about 1 part, more preferably equal to or greater than about 2 parts, more preferably equal to or greater than about 5 parts, and more preferably equal to or greater than about 10 parts by weight based on the weight of the ignition resistant carbonate polymer composition. If present, the thermoplastic vinyl (co)polymer (iii) is present in an amount equal to or less than about 45 parts by weight, preferably equal to or less than about 40 parts, more preferably equal to or less than about 35 parts, more preferably equal to or less than about 30 parts, and more preferably equal to or less than about 25 parts by weight based on the weight of the ignition resistant carbonate polymer composition.

Component (iv) of the present invention is an aromatic polyphosphonate that has the structure IV:

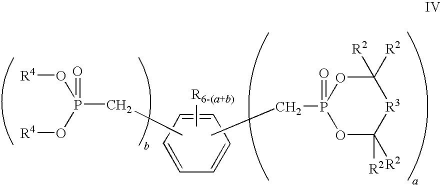

wherein a and b are each from 0 to 6, with a+b being from 2 to 6, each R is independently hydrogen, unsubstituted or inertly substituted alkyl having up to 6 carbon atoms, —NO₂, —NR¹₂, —C≡N, —OR¹, —C(O)OR¹, or —C(O)NR¹₂ (wherein R¹ is hydrocarbyl or hydrogen), each R² is independently hydrogen, alkyl or inertly substituted alkyl, each R³ is a covalent bond or a divalent linking group, such as a disubstituted methylene:

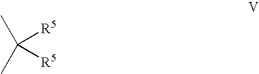

where each R⁵ is independently hydrogen, an alkyl, aryl, inertly substituted alkyl or inertly substituted aryl group and each R⁴ is independently an alkyl, aryl, inertly substituted alkyl or inertly substituted aryl group.

In an embodiment in which b is zero, the aromatic polyphosphonate is represented by structure VI

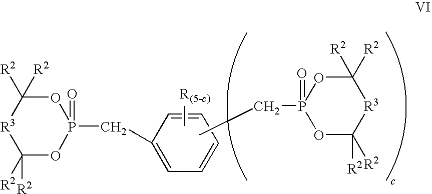

wherein c is 1 to 5 and R, R² and R³ are as defined before, c is preferably from 1 to 3 and is most preferably 1. When c is 1, the aromatic polyphosphonate is represented by structure VII as follows:

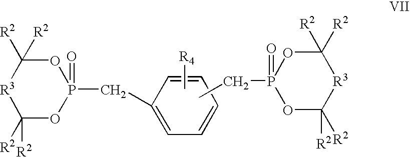

wherein R, R² and R³ are as before. In structure VII, the methylene phosphonate groups may be para, meta or ortho to each other.

In each of structures IV-VII, each R is preferably hydrogen or unsubstituted alkyl having up to 4 carbon atoms. Each R is more preferably hydrogen or methyl. Each R is most preferably hydrogen. Each R² is preferably hydrogen, and each R³ is preferably an alkylene diradical having no hydrogens on the carbon atom(s) bonded directly to the adjacent (R²)₂C groups, R³ is more preferably dialkyl-substituted methylene and most preferably dimethylmethylene (propylidene).

Preferred polyphosphonates include those having structures VIII and IX:

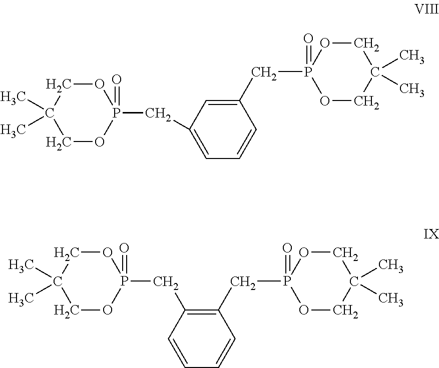

In another embodiment in which b is zero, each R² is hydrogen and each R³ is a disubstituted methylene, the aromatic polyphosphonate is represented by structure X as follows:

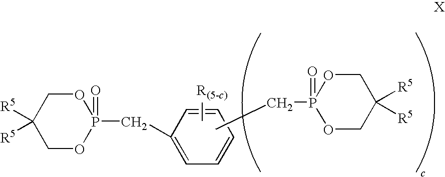

wherein and R and R⁵ are defined as before and c is 1 to 5, preferably from 1 to 3 and is most preferably 2 or 3. In structure X, the methylene phosphonate groups may be para, meta or ortho to each other.

Preferred polyphosphonates include those having structures XI and XII:

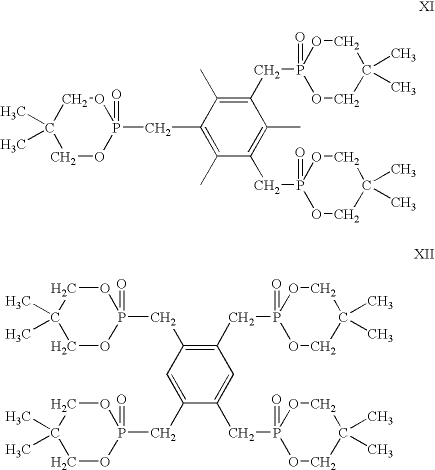

In an embodiment in which a in structure IV is zero, the aromatic polyphosphonate is represented by structure XIII:

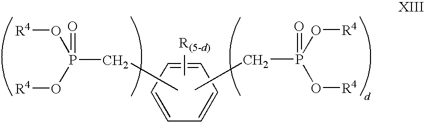

wherein d is from 1 to 5 and R and R⁴ are as defined before, d is preferably from 1 to 3 and is most preferably 1. When d is one, the aromatic polyphosphonate is represented by structure XIV as follows:

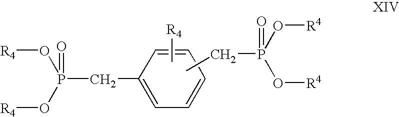

wherein R and R⁴ are as defined before. In structure XIV, the methylene phosphonate groups may be para, meta or ortho to each other.

In structures XIII and XIV, R is preferably hydrogen or unsubstituted alkyl having up to 4 carbon atoms, and is most preferably hydrogen. In structures IV, XIII and XIV, R⁴ is preferably C₁-C₄ alkyl, phenyl or benzyl.

The term “inertly substituted”, when used herein in connection with the polyphosphonate, means that the substituent group is one that does not undesirably interfere with the flame retardant properties of the compound or undesirably reduce the 5 percent weight loss temperature. The inert substituent may be, for example, an oxygen-containing group such as an ether, ester, carbonyl, hydroxyl, carboxylic acid, oxirane group and the like. The inert substituent may be a nitrogen-containing group such as a primary, secondary or tertiary amine group, an imine group, a nitrile group, or a nitro group. The inert substituent may be a nitrogen- and oxygen-containing group such as an amide group. The inert substituent may contain other hetero atoms such as sulfur, phosphorus, silicon (such as silane or siloxane groups) and the like. The inert substituent is preferably not a halogen.

The polyphosphonates can be prepared in various ways, including those described in U.S. Pat. No. 4,268,459. A convenient way is to react an alkyl ester of the corresponding cyclic phosphite with a halomethyl-substituted benzene compound. This reaction is sometimes referred to as an “Arbuzov” reaction, and is described, for example, in C.A. 47: 9900 et seq. Such reactions are shown schematically in structures XV and XVI:

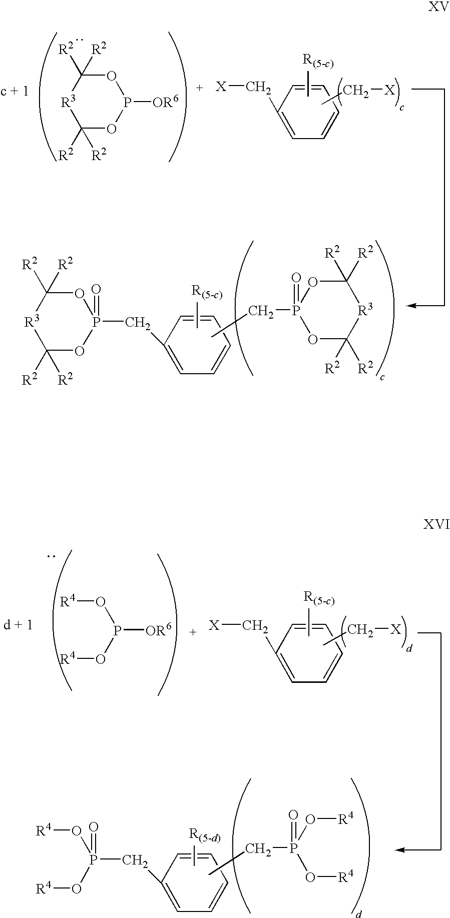

wherein c, d, R, R², R³ and R⁴ are as described before, R⁶ is an alkyl group which is preferably methyl, ethyl, or isopropyl and each X is a halogen, preferably chlorine or bromine. In the reactions illustrated in structures XV and XVI, the halomethyl-substituted benzene compound is preferably a 1,4-bis(halomethyl)benzene, a 1,3-bis(halomethyl)benzene, a 1,2-bis(halomethyl)benzene or a 1,4 bis(halomethyl)-2,5-dimethylbenzene.

The cyclic phosphonic acid ester starting materials that are used in the reaction shown in structure XV can be prepared by reacting PCl₃ with a diol (such as 1,3-propylene glycol or, preferably, neopentyl glycol) and an alcohol corresponding to R⁶OH. This manner of preparing the starting material is described by McConnell et al., J. Org. Chem. Vol. 24, pp. 630-635 (1959), as well as in U.S. Pat. No. 4,268,459 which is incorporated herein by reference.

An alternative route to making the polyphosphonates of the invention is by first reacting a trialkyl phosphite with a halomethyl-substituted benzene compound to form an intermediate ester, and then reacting the intermediate ester with, on one hand, a diol (such as 1,3-propylene glycol or, preferably, neopentyl glycol) to form cyclic phosphonate groups, and/or, a monoalcohol of the form R⁴OH to form non-cyclic phosphonate groups. Again, the halomethyl-substituted benzene compound is preferably 1,4-bis(halomethyl)benzene, 1,3-bis(halomethyl)benzene, 1,2-bis(halomethyl)benzene or 1,4 bis(halomethyl)-2,5-dimethylbenzene. Such a reaction scheme is described with respect to forming cyclic phosphonate groups in U.S. Pat. No. 4,268,459 which is incorporated herein by reference.

A third route involves forming a dialkyl ester of phosphonic acid, reacting the ester with an alkali metal hydride to form the corresponding alkali metal salt (preferably sodium or potassium salt), and then reacting the resulting alkali metal salt with the halomethyl-substituted benzene compound. As before, the bis(halomethyl)-substituted benzene compound is preferably 1,4-bis(halomethyl)benzene, 1,3-bis(halomethyl)benzene, 1,2-bis(halomethyl)benzene or 1,4 bis(halomethyl)-2,5-dimethylbenzene. This reaction scheme is described with respect to forming cyclic phosphonate groups in U.S. Pat. No. 4,268,459 which is incorporated herein by reference.

The aromatic phosphonate compound (iv) is present in an amount equal to or greater than about 0.5 parts by weight, preferably equal to or greater than about 1 part, more preferably equal to or greater than about 2 parts, more preferably equal to or greater than about 5 parts, and more preferably equal to or greater than about 10 parts by weight based on the weight of the ignition resistant carbonate polymer composition. The aromatic phosphonate compound (iv) is present in an amount equal to or less than about 40 parts by weight, preferably equal to or less than about 35 parts, more preferably equal to or less than about 25 parts, more preferably equal to or less than about 20 parts, and more preferably equal to or less than about 15 parts by weight based on the weight of the ignition resistant carbonate polymer composition.

Fluorinated polyolefins may be added as component (v). Such polymers are often referred to as polytetrafluoroethylene (PTFE) or TEFLON™. Suitable fluorinated polyolefins (v) are those adapted to form a fibril structure to reduce the tendency of the polymer composition to drip. They typically have a high molecular weight and have a glass transition temperature of above −30° C., generally of above 100° C.; a fluorine content preferably from 65 to 76 weight percent, in particular of 70 to 76 weight percent; an average particle diameter from 0.05 microns to 1000 microns, preferably of 0.08 microns to 20 microns. The fluorinated polyolefins (v) generally have a density of 1.2 to 2.3 g/cm³. Preferred fluorinated polyolefins (v) are polytetrafluoroethylene, polyvinylidene fluoride, tetrafluoroethylene/hexafluoropropylene and ethylene/tetrafluoroethylene copolymers.

The fluorinated polyolefins are known (c.f. Vinyl & Related Polymers by Schildknecht, John Wiley & Sons Inc., New York, 1962, pp. 484-494; Fluoropolymers by Wall, Wiley-Interscience, John Wiley & Sons Inc., New York, volume 13, 1970, pp. 623-654; Modern Plastics Encyclopedia, 1970-1971, volume 47, no. 10 A, October 1970, McGraw-Hill Inc., New York, pp. 134 and 774; Modern Plastics Encyclopedia, 1975-1976, October 1975, volume 52, no. 10A, McGraw-Hill Inc., New York, pp. 27, 28 and 472 and U.S. Pat. Nos. 3,005,795; 3,671,487; 3,723,373; 3,838,092; and 4,463,130 which are incorporated by reference.)

They may be produced using known processes, thus for example by polymerizing tetrafluoroethylene in an aqueous medium with a free-radical forming catalyst, for example sodium, potassium or ammonium peroxydisulfate, at pressures of 7 to 71 kg/cm² and at temperatures of 0 to 200° C., preferably at temperatures of 20 to 100° C. (see, for example, U.S. Pat. No. 2,393,967 for further details). Depending upon the form in which they are used, the density of these materials may be between 1.2 and 2.3 g/cm³, the average particle size between 0.5 microns and 1000 microns.

Preferred fluorinated polyolefins (v) according to the invention are tetrafluoroethylene polymers having average particle diameters of 0.05 microns to 20 microns, preferably of 0.08 microns to 10 microns, and a density of 1.2 to 1.9 g/cm³. One desirable form is as a coagulated mixture of emulsions of the tetrafluoroethylene polymers (v) with emulsions of the graft polymers (ii). Suitable tetrafluoroethylene polymer emulsions are conventional commercial products and are offered for sale, for example, by DuPont as TEFLON 30N.

Another desirable form of fluorinated polyolefins (v) is as powder tetrafluoroethylene polymers having average particle diameters of 100 microns to 1000 microns and densities of 2.0 to 2.3 g/cm³ and are offered for sale by the companies DuPont for example grades TEFLON 6C, 60, 6CN, 64, 65, and 67 and by Dyneon GmbH (Burgkirchen, Germany) under the commercial name HOSTAFLON™ PTFE.

If present, the fluorinated polyolefin (v) is present in an amount equal to or greater than about 0.01 parts by weight, preferably equal to or greater than about 0.05 parts, more preferably equal to or greater than about 0.1 parts, and more preferably equal to or greater than about 0.5 parts by weight based on the weight of the ignition resistant carbonate polymer composition. If present, the fluorinated polyolefin (v) is present in an amount equal to or less than about 5 parts by weight, preferably equal to or less than about 4 parts, more preferably equal to or less than about 3 parts, and more preferably equal to or less than about 2 parts by weight based on the weight of the ignition resistant carbonate polymer composition. Preferably, the fluorinated polyolefin is present from 0 to about 3 parts by weight based on the weight of the ignition resistant carbonate polymer composition.

The ignition resistant carbonate polymer compositions according to the invention may contain at least one of the conventional additives, such as lubricants and mold release agents, for example pentaerythritol tetrastearate, nucleating agents, anti-static agents, stabilizers, fillers and reinforcing materials as well as dyes and pigments.

The ignition resistant carbonate polymer compositions of the present invention may further comprise a filler and/or reinforcing material. Preferred fillers, which may also have a reinforcing action, are glass fibers, glass beads, mica, silicates, quartz, talcum, titanium dioxide, and/or wollastonite alone or in combinations.

If present, the filler and/or reinforcing material is present in an amount equal to or greater than about 0.5 parts by weight, preferably equal to or greater than about 1 part, more preferably equal to or greater than about 2 parts, more preferably equal to or greater than about 5 parts, and more preferably equal to or greater than about 10 parts by weight based on the weight of the ignition resistant carbonate polymer composition. If present, the filler and/or reinforcing material is present in an amount equal to or less than about 60 parts by weight, preferably equal to or less than about 40 parts, more preferably equal to or less than about 30 parts, more preferably equal to or less than about 25 parts, and more preferably equal to or less than about 20 parts by weight based on the weight of the ignition resistant carbonate polymer composition.

The ignition resistant carbonate polymer compositions according to the invention may contain up to 35 weight percent, relative to the overall ignition resistant carbonate polymer composition, of a further, optionally synergistic flame retardant. Examples of further flame retardants which may be mentioned are organic halogen compounds, such as decabromobisphenyl ether, tetrabromobisphenol, inorganic halogen compounds such as ammonium bromide, nitrogen compounds, such as melamine, melamine/formaldehyde resins, inorganic hydroxide compounds, such as Mg, Al hydroxide, inorganic compounds such as antimony oxides, barium metaborate, hydroxoantimonate, zirconium oxide, zirconium hydroxide, molybdenum oxide, ammonium molybdate, zinc borate, ammonium borate, barium metaborate, talcum, silicate, silicon oxide and tin oxide, as well as siloxane compounds. Monophosphate compounds, oligomeric phosphate compounds or mixtures thereof may additionally be used as flame retardants. Such phosphorus compounds are described in U.S. Pat. Nos. 5,061,745; 6,596,794; 6,727,301; 6,753,366; and Re 36,188, all of which are incorporated herein by reference.

The ignition resistant carbonate polymer compositions comprising (i) and (iii) and optionally (ii), (iv), (v), stabilizers, dyes, pigments, lubricants and mold release agents, nucleating agents, as well as antistatic agents, fillers and reinforcing materials are produced by mixing the particular constituents in a known manner and melt-compounding and/or melt-extruding them at temperatures of 200° C. to 300° C. in conventional units such as internal kneaders, extruders and twin-screw extruders, wherein component (v) is preferably used as a powder or in the form of the above-mentioned coagulated mixture.

The individual constituents may be mixed in a known manner both in succession and simultaneously and both at approximately 23° C. (room temperature) and at a higher temperature.

The present invention accordingly also provides a process for the production of the ignition resistant carbonate polymer compositions.

By virtue of their excellent ignition resistance, in particular short burn time, and good mechanical properties and elevated heat resistance, the ignition resistant carbonate polymer compositions according to the invention are suitable for the production of articles of any kind, in particular those subject to stringent requirements with regard to mechanical properties.

The ignition resistant carbonate polymer compositions of the present invention are thermoplastic. When softened or melted by the application of heat, the ignition resistant carbonate polymer compositions of this invention can be formed or molded into articles using conventional techniques such as compression molding, injection molding, gas assisted injection molding, calendaring, vacuum forming, thermoforming, extrusion and/or blow molding, alone or in combination. The ignition resistant polymer compositions can also be formed, spun, or drawn into films, fibers, multi-layer laminates or extruded into sheets and/or profiles. Examples of formed articles which may be produced are: enclosures of all kinds, for example for domestic appliances such as juice extractors, coffee machines, food mixers, for office equipment, such as monitors, printers, copiers or cladding sheet for the building sector and automotive components. They may also be used in electrical engineering applications as they have very good electrical properties.

The ignition resistant carbonate polymer compositions according to the invention may furthermore, for example, be used to produce the following formed articles or shaped articles: interior trim for rail vehicles, interior and exterior automotive applications, enclosures for electrical devices containing small transformers, enclosures for information dissemination and transmission devices, enclosures and cladding for medical purposes, massage devices and enclosures therefore, toy vehicles for children, sheet wall elements, enclosures for safety equipment, hatchback spoilers, thermally insulated transport containers, apparatus for keeping or caring for small animals, articles for sanitary and bathroom installations, cover grilles for ventilation openings, articles for summer houses and sheds, and enclosures for garden appliances. Preferred fabricated articles include instrument housings such as for power tools, appliances, consumer electronic equipment such as TVs, VCRs, web appliances, electronic books, etc., or information technology equipment such as telephones, computers, monitors, fax machines, battery chargers, scanners, copiers, printers, hand held computers, flat screen displays, etc.

The present invention accordingly also provides the use of the ignition resistant carbonate polymer compositions according to the invention for the production of articles of all kinds, preferably those stated above, and the articles made from the ignition resistant carbonate polymer compositions according to the invention.

### EXAMPLES

To illustrate the practice of this invention, examples of preferred embodiments are set forth below. However, these examples do not in any manner restrict the scope of this invention.

The following polyphosphonates are prepared for use in PC/ABS blend compositions in Examples 1 to 3:

“PP-1” is the polyphosphonate 2,2′-[1,3-phenylenebis(methylene)]bis[5,5-dimethyl-1,3,2-dioxaphosphorinane] 2,2′-dioxide. PP-1 is prepared by combining (neopentyl)isopropylphosphite (20.110 gram (g), 104.6 mmol, α,α′-dibromo-m-xylene (13.152 g, 49.83 mmol) and 40 milliliter (mL) of xylene in a Schlenk flask equipped with a distillation head which has a jacketed Vigreux column and a thermometer. The system is evacuated, placed under nitrogen, and the reaction flask is placed in a wax bath heated to 150° C. Within a few minutes, distillate begins to collect at a very rapid rate and a solid begins to form. The flask is removed from the bath and the distillate is returned to the reaction flask. The flask is replaced in the hot wax bath, so that just a few millimeters of flask are being heated. 2-Bromopropane distills off slowly. The bath is allowed to cool to ambient temperature. The solid mass which has formed is filtered, washed with 20 mL of xylene, washed with 20 mL of hexane and dried to give the product 2,2′-[1,3-phenylenebis(methylene)]bis[5,5-dimethyl-1,3,2-dioxaphosphorinane] 2,2′-dioxide as a mixture of powder and crystalline chunks. The yield is 11.781 g, 58.75 percent. Proton, ¹³C and ³¹P NMR spectra on the product exhibit the following features:

¹H NMR (299.99 MHz, CDCl₃, vs TMS) δ: 7.2-7.3 (m, 4H), 4.16 (d of d, 4H, J=11.0 Hz, J=7.8 Hz), 3.72 (d of d, 4H, J=14.2 Hz, J=11.2 Hz), 3.26 (d, 4H, J=22.0 Hz), 0.96 (s, 6H), 0.86 (s, 6H).

¹³C NMR (75.44 MHz, CDCl₃, vs TMS) δ: 131.37 (t, J=6.4 Hz), 131.25 (t, J=6.4 Hz), 128.91 (t, J=3.4 Hz), 128.69 (t. J=5.0 Hz), 75.31 (inverted t, J=3.4 Hz), 33.36, 32.49 (inverted t, J=3.0 Hz), 31.57, 21.41, 21.31.

³¹P NMR (121.44 MHz, CDCl₃, vs H₃PO₄) δ: 22.18.

2,2′-[1,3-phenylenebis(methylene)]bis[5,5-dimethyl-1,3,2-dioxaphosphorinane] 2,2′-dioxide has the following structure:

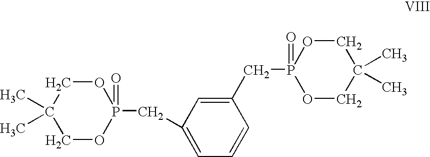

“PP-2” is the polyphosphonate 2,2′,2″-[(2,4,6-trimethyl-1,3,5-benzenetriyl) tris(methylene)]tris[5,5-dimethyl-1,3,2-dioxaphosphorinane] 2,2′,2″-trioxide. It is prepared by combining neopentyl isopropylphosphite (14.745 g, 76.72 mmol), 1,3,5-(bromomethyl)-2,4,6-trimethylbenzene (tribromomesitylene) (6.05 g, 15.16 mmol) and 40 mL of xylene in a 100 mL one-necked flask equipped with a stir bar and a distillation head which has a jacketed Vigreux column and a thermometer. The tribromomesitylene did not dissolve much in the phosphite/xylene mixture. The system is evacuated, placed under nitrogen, and the reaction flask is gradually heated up to a wax bath temperature of about 110° C., during which time the tribromomesitylene dissolved, and held in that temperature range for about 1 to 2 hours under distillation of i-Pr—Br and formation of a large amount of white solid.

The wax bath is heated to about 150° C. for three hours under formation of more white solid (the amount of solid appeared greater). The temperature is raised to about 170° C. for 2 hours, then the reaction mixture is allowed to cool to ambient temperature. The slurry is filtered. The solid is washed twice with about 35 mL of xylene each time, washed twice with about 35 mL of hexane each time and dried under reduced pressure to give the colorless crystalline product. The yield is 7.6124 g, 82.76 percent. The NMR spectra show very high purity. Proton, ¹³C and ³¹P NMR spectra on the product exhibit the following features:

¹H NMR (299.985 MHz, CDCl₃, vs TMS) δ: 4.15 (d of d, 6H, J=10.9 Hz, J=6.5 Hz), 3.64 (d of d, 6H, J=15.4 Hz, J=11.2 Hz), 3.48 (d, 6H, J=22.7 Hz), 2.45 (d, 9H, J=2.0 Hz), 0.94 (s, 9H), 0.93 (s, 9H)

¹³C NMR (75.438 MHz, CDCl₃, vs CDCl₃) δ: 135.84 (pseudo q, J=5.4 Hz, J=6.0 Hz), 127.09 (pseudo q, J=5.4 Hz, J=7.4 Hz), 74.84 (d, J=6.0 Hz), 32.35 (d, J=5.4 Hz), 28.75 (d, J=136.2), 21.36, 21.15, 18.01 (d, J=1.3 Hz).

³¹P NMR (121.436 MHz, CDCl₃, vs H₃PO₄) δ: 23.70.

2,2′,2″-[(2,4,6-trimethyl-1,3,5-benzenetriyl)tris(methylene)]tris[5,5-dimethyl-1,3,2-dioxaphosphorinane] 2,2′,2″-trioxide has the following structure:

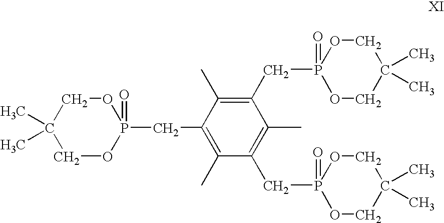

“PP-3 is the polyphosphonate 2,2′,2″,2′″-[(1,2,4,5-benzenetetrayl)tetrakis (methylene)]tetrakis [5,5-dimethyl-1,3,2-dioxaphosphorinane] 2,2′,2″, 2′″-tetroxide. PP-3 is prepared by combining neopentyl isopropylphosphite (27.021 g, 140.59 mmol), 1,2,4,5-tetra(bromomethyl)benzene (10.540 g, 23.43 mmol) and 40 mL of xylene in a 100 mL one-necked flask equipped with a stir bar and a distillation head which has a jacketed Vigreux column and a thermometer. The system is evacuated, placed under nitrogen, and the reaction flask is gradually heated up to a wax bath temperature of about 110° C. and held at about that temperature for about 1 to 2 hours under distillation of i-Pr—Br and formation of a large amount of white solid. The wax bath is heated to about 160° C. for four hours. The temperature is raised to about 190° C. for 2 more hours, then the reaction mixture is allowed to cool to ambient temperature. The slurry is filtered. The solid is washed twice with about 35 mL of xylene, washed twice with about 35 mL of hexane and dried under reduced pressure to give the product as a white powder. The yield was 16.45 g, 96.6 percent. The compound is soluble in methanol, slightly soluble in DMSO and only very slightly soluble in chloroform, but appears to be insoluble in acetone, water, toluene, and hexane.

ES-MS shows the product to be a mixture of about 90 percent of the desired tetraphosphonate ([MNa⁺]=749.2) and about 10 percent of the bromo-triphosphonate ([MNa⁺]=681.1).

The white powder is combined in a flask with 2 equivalents (9.2 g) of neopentyl isopropylphosphite and about 30 mL of xylene. The reaction mixture is heated for about 1.5 days at about 150° C. then for 3 days at 180° C., then one day at 190° C. The reaction mixture is cooled, then filtered, washed twice with 50 mL of xylene, three times with 50 mL of toluene, twice with 50 mL of heptane, and three times with 50 mL of hexane and dried under suction filtration. The yield of white powder is 15.599 g, 91.62 percent. 2,2′,2″, 2′″-[(1,2,4,5-benzenetetrayl)tetrakis(methylene)]tetrakis [5,5-dimethyl-1,3,2-dioxaphosphorinane] 2,2′,2″, 2′″-tetroxide has the following structure:

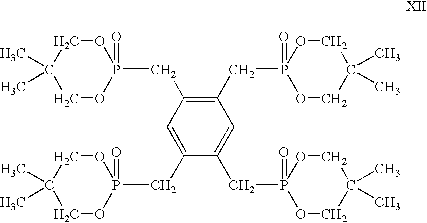

The compositions of Examples 1 to 3 are melt compounded in a Haake Rheocord 90 Mixer, fitted with a 50 cubic centimeter (cc) capacity mixing chamber with standard “Roller Type” mixing blades. Approximately 100 cc of each formulation is made.

A polymer masterbatch comprising components (i), (ii), (iii), and component (v), formed by melt blending the components, was used. The polymer masterbatch is weighed into a first container and the polyphosphonate (component (iv)) is weighed into a second container. The Haake Rheocord Mixer's melting heaters are set at 235° C. and the mixing blades speed set at 60 revolutions per minute (rpm). After the Haake Rheocord control program is initiated, approximately ⅓ of the volume of the polymer masterbatch is added to the mixing bowl and allowed to melt. Once the torque has dropped and stabilized, approximately ⅓ of the polyphosphonate is added to the melt. Small amounts of the remaining polymer masterbatch and polyphosphonate are alternatively added until all of the ingredients are in the mixing bowl. Addition of components into the mixing chamber is completed within 2 to 3 minutes and the mixing is continued for 16 to 18 more minutes.

Underwriters' Laboratories 94 (UL 94) burn test specimens are injection molded on a Watson-Stillman plunger type injection molding machine (Watson-1, K 1802) with the following parameters: Melt Temperature: 250° C.; Mold Temperature: 60° C.; and Injection Hydraulic Pressure: 1500 pounds per square inch (psi).

The formulation content of Examples 1 to 3 and UL 94 burn performance are given in Table 1, amounts are in parts by weight. In Table 1:

“PC” is a bisphenol-A polycarbonate homopolymer having a melt flow of 23 and commercially available as CALIBRE™ 300-22 from the Dow Chemical Company.

“mABS” is a mass polymerized acrylonitrile, butadiene, and styrene terpolymer having about 15 percent acrylonitrile, 12 percent butadiene rubber, and an average rubber particle size (Dv) as determined by Coulter Counter of 1.2 microns;

“eABS” is an emulsion polymerized acrylonitrile, butadiene, and styrene terpolymer having about 12 percent acrylonitrile and 48 percent butadiene rubber;

“PP-1” is the polyphosphonate 2,2′-[1,3-phenylenebis(methylene)]bis[5,5-dimethyl-1,3,2-dioxaphosphorinane] 2,2′-dioxide prepared as described hereinabove, (structure VIII);

“PP-2” is 2,2′,2″-[(2,4,6-trimethyl-1,3,5-benzenetriyl)tris(methylene)]tris[5,5-dimethyl-1,3,2-dioxaphosphorinane] 2,2′,2″-trioxide prepared as described hereinabove, (structure XI);

“PP-3” is 2,2′,2″, 2′″-[(1,2,4,5-benzenetetrayl)tetrakis(methylene)]tetrakis [5,5-dimethyl-1,3,2-dioxaphosphorinane] 2,2′,2″, 2′″-tetroxide prepared as described hereinabove, (structure XII);

“PTFE” is a fibril forming polytetrafluoroethylene polymer powder from DuPont Chemical Company available under the name of ALGOFLON™ DF210.

“UL-94” flammability test is performed on 1.6 millimeter (mm) test specimens, burn times are reported in seconds (s), and the ratings are according to the standard.

TABLE 1

| | Example 1 | Example 2 | Example 3 |
|---|---|---|---|
| Components | | | |
| PC | 70.6 | 70.6 | 70.6 |
| mABS | 10 | 10 | 10 |
| eABS | 5 | 5 | 5 |
| PP-1 | 14 | | |
| PP-2 | | 14 | |
| PP-3 | | | 14 |
| PTFE | 0.4 | 0.4 | 0.4 |
| UL 94 | | | |
| Rating | V-1 | V-1 | V-1 |
| Total burn time, s | 162 | 213 | 326 |
| Flaming drips | No | No | No |
| Maximum individual burn time, s | 25 | 61 | 23 |

1. An ignition resistant carbonate polymer composition comprising:
(i) from 40 to 99 parts by weight of an aromatic polycarbonate or an aromatic polyester carbonate,
(ii) from 0 to 60 parts by weight of a graft polymer of
(ii.a) from 5 to 95 percent by weight of one or more vinyl monomers on
(ii.b) from 95 to 5 percent by weight of one or more grafting backbones with a glass transition temperature (T_{g}) of less than 10° C.,
(iii) from 0 to 45 parts by weight of at least one thermoplastic vinyl (co)polymer,
(iv) from 0.5 to 40 parts by weight of an aromatic polyphosphonate compound represented by the structure: 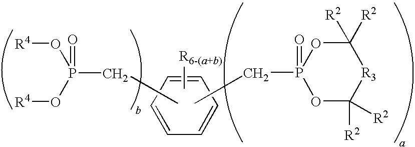
wherein a and b are each from 0 to 6, with a+b being from 2 to 6, each R is independently hydrogen, unsubstituted or inertly substituted alkyl having up to 6 carbon atoms, —NO₂, —NR¹₂, —C≡N, —OR¹, —C(O)OR¹, or —C(O)NR¹₂ (wherein R¹ is hydrocarbyl or hydrogen), each R² is independently hydrogen, alkyl or inertly substituted alkyl, each R³ is a covalent bond or a divalent linking group, and each R⁴ is independently an alkyl, aryl, inertly substituted alkyl or inertly substituted aryl group and
(v) from 0 to 3 parts by weight of a fluorinated polyolefin.

2. The ignition resistant carbonate polymer composition of claim 1 wherein the aromatic polyphosphonate is represented by the structure: 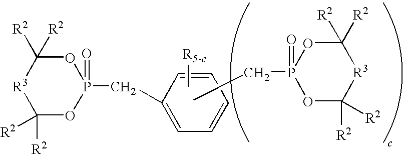
wherein c is 1 to 5, each R is independently hydrogen, unsubstituted or inertly substituted alkyl having up to 6 carbon atoms, —NO₂, —NR¹₂, —C≡N, —OR¹, —C(O)OR¹, or —C(O)NR¹₂ (wherein R¹ is hydrocarbyl or hydrogen), each R² is independently hydrogen, alkyl or inertly substituted alkyl and each R³ is a covalent bond or a divalent linking group.

3. The ignition resistant carbonate polymer composition of claim 2, wherein each R is hydrogen or unsubstituted alkyl having up to 4 carbon atoms; each R² is hydrogen; each R³ is an alkylene diradical having no hydrogens on the carbon atom(s) bonded directly to the adjacent (R²)₂C groups, and c is from 1 to 3.

4. (canceled)

5. The ignition resistant carbonate polymer composition of claim 1 wherein the aromatic polyphosphonate is represented by the structure:

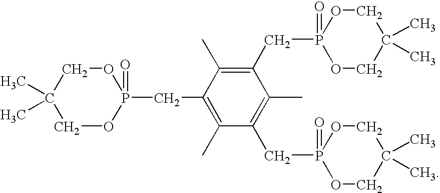

6. The ignition resistant carbonate polymer composition of claim 1 wherein the aromatic polyphosphonate is represented by the structure:

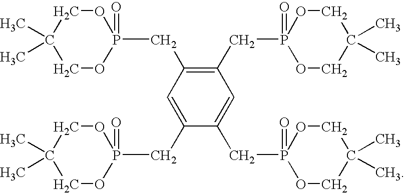

7. The ignition resistant carbonate polymer composition of claim 3, wherein the aromatic polyphosphonate is represented by the structure:

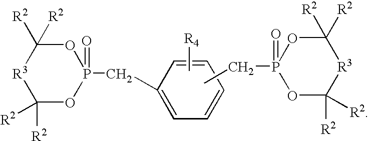

8. The ignition resistant carbonate polymer composition of claim 3, wherein the aromatic polyphosphonate is represented by the structure:

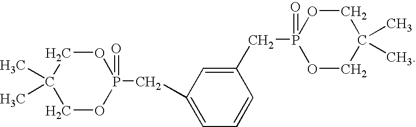

9. The ignition resistant carbonate polymer composition of claim 3, wherein the aromatic polyphosphonate is represented by the structure:

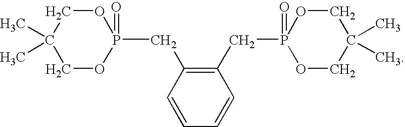

10. The ignition resistant carbonate polymer composition of claim 1, wherein the aromatic polyphosphate is represented by structure: 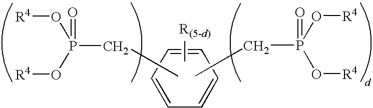
wherein d is from 1 to 5.

11. The ignition resistant carbonate polymer composition of claim 10, wherein the aromatic polyphosphate is represented by the structure:

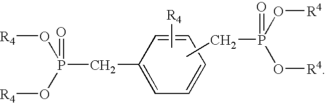

12. The ignition resistant carbonate polymer composition of claim 1 wherein component (ii) is present in an amount of from about 0.5 to about 60 parts by weight.

13. The ignition resistant carbonate polymer composition of claim 1 wherein component (iii) is present in an amount of from about 2 to 25 parts by weight.

14. The ignition resistant carbonate polymer composition of claim 1 wherein component (iv) is present in an amount of from about 1 to 20 parts by weight.

15. The ignition resistant carbonate polymer composition of claim 1 wherein component (v) is present in an amount of from about 0.05 to 3 parts by weight.

16. The ignition resistant carbonate polymer composition of claim 1 wherein the ratio by weight of components (ii):(iii) is between 2:1 and 1:4.

17. The ignition resistant carbonate polymer composition of claim 1 wherein graft base (ii.b) is a diene rubber, an acrylate rubber, a silicone rubber, or an ethylene-propylene diene rubber.

18. The ignition resistant carbonate polymer composition of claim 1 further comprising from about 1 to 40 parts by weight of one or more of glass fibers, glass beads, mica, silicates, quartz, talcum, titanium dioxide, or wollastonite alone or in combination.

19. A method for making an ignition resistant carbonate polymer composition comprising the step of melt-compounding:
(i) from 40 to 99 parts by weight of an aromatic polycarbonate or an aromatic polyester carbonate,
(ii) from 0 to 60 parts by weight of a graft polymer of
(ii.a) from 5 to 95 percent by weight of one or more vinyl monomers on
(ii.b) from 95 to 5 percent by weight of one or more grafting backbones with a glass transition temperature (T_{g}) of less than 10° C.,
(iii) from 0 to 45 parts by weight of at least one thermoplastic vinyl (co)polymer,
(iv) from 0.5 to 40 parts by weight of an aromatic polyphosphonate compound represented by the structure: 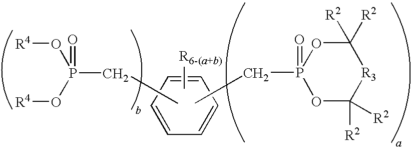
wherein a and b are each from 0 to 6, with a+b being from 2 to 6, each R is independently hydrogen, unsubstituted or inertly substituted alkyl having up to 6 carbon atoms, —NO₂, —NR¹₂, —C≡N, —OR¹, —C(O)OR¹, or —C(O)NR¹₂ (wherein R¹ is hydrocarbyl or hydrogen), each R² is independently hydrogen, alkyl or inertly substituted alkyl, each R³ is a covalent bond or a divalent linking group, and each R⁴ is independently an alkyl, aryl, inertly substituted alkyl or inertly substituted aryl group and
(v) from 0 to 3 parts by weight of a fluorinated polyolefin.

20. A formed article comprising the ignition resistant carbonate polymer of claim 1.

21. The formed article of claim 20 made by one or more of the following fabricating processes: compression molding, injection molding, gas assisted injection molding, calendaring, vacuum forming, thermoforming, extrusion, or blow molding, alone or in combination.
